(19) United States
(12) Patent Application Publication
(10) Pub. No.: US 2012/0288949 A1
(43) Pub. Date: Nov. 15, 2012

(54) DETECTION METHOD AND SENSOR BASED ON INTERPARTICLE DISTANCE

(76) Inventors: Si Yin TEE, Singapore (SG); Enyi Ye, Singapore (SG); Yin Win Khin, Singapore (SG); Suo Hon Lim, Singapore (SG); Mingyong Han, Singapore (SG)

(21) Appl. No.: 13/420,523

(22) Filed: Mar. 14, 2012

Related U.S. Application Data
(60) Provisional application No. 61/465,139, filed on Mar. 14, 2011.

(51) Int. Cl. G01N 21/64; B82Y 15/00

(52) U.S. Cl. 436/104; 436/172; 436/106; 977/773; 977/902; 977/811

(57) ABSTRACT

The present invention relates to a method for determining the presence or amount of a compound in a sample by interparticle distance-dependent sensing, comprising:
(a) contacting the sample suspected of containing the compound with rare earth doped metal oxide nanoparticles; and
(b) detecting the compound by determining the change in luminescent properties of the rare earth doped metal oxide nanoparticles upon contact with the sample.

### CROSS-REFERENCE TO RELATED APPLICATION

This application claims the benefit of priority of U.S. Provisional Patent Application No. 61/465,139, filed 14 Mar. 2011, the contents of which being hereby incorporated by reference in its entirety for all purposes.

### TECHNICAL FIELD

The invention relates to detection methods and devices based on interparticle distance between nanoparticles, and in particular, to detection methods and devices based on interparticle distance between rare earth doped metal oxide nanoparticles.

### BACKGROUND

Rare earth (RE) ions are well known for their photoluminescence (PL) properties which attracted much research since the past century. Until now, RE ions doped luminescent materials remain significant technological importance and tremendous improvement has been made in this field by incorporating RE ions as the luminescent centers. Their luminescent applications are extensively used as high performance luminescent devices, biomedical devices, microscopy, and many more. Their excellent luminescent properties are resulted from the electronic transitions between the 4f energy levels. These transitions are electric dipole forbidden and luminescence decay times of the emitting 4fⁿ levels are typically in the micro-seconds (μs) to milli-seconds (ms) region. Conversely, transitions between the 4fⁿ levels and levels of the 4fⁿ⁻¹ 5d configuration are allowed and luminescence decay time in the order of nano-seconds (ns) have been observed.

Theoretical and experimental research on the electronic energy level transitions of the trivalent RE in the ultraviolet-visible (UV) region has been well studied and this provides a basis for the development of luminescent materials. The energy of the various 4f-levels of the RE doped in LaCl₃ was reported to be up to energies of 40,000 cm⁻¹. This research has been further extended to the vacuum LUV region in the later study using RE incorporated in LiYF₄. In the high-resolution excitation spectra of the heavy trivalent RE with more than half-filled 4f shell (n>7), weak bands are observed at the longer wavelength side of the well known strong f-d bands. These weak bands are assigned to transitions to the lowest 4fⁿ⁻¹ 5d state, which has a higher spin quantum number than the 4fⁿ ground state. As a consequence these transitions are spin forbidden, which is weaker than the allowable f-d bands.

### SUMMARY

The present inventors have made a new detection discovery for the sensing technologies by making use of the interparticle distance between metal oxide nanoparticles doped with rare earth ions. Rare earth ions are used due to their unique luminescent properties which are related to their electronic energy transition.

Thus, according to a first aspect of the invention, there is provided a method for determining the presence or amount of a compound in a sample by interparticle distance-dependent sensing. The method includes:

(a) contacting the sample suspected of containing the compound with rare earth doped metal oxide nanoparticles; and

(b) detecting the compound by determining the change in luminescent properties of the rare earth doped metal oxide nanoparticles upon contact with the sample.

According to a second aspect of the invention, there is provided a sensor for use in a method of detecting the presence of amount of a compound in a sample, wherein the sensor comprises rare earth doped metal oxide nanoparticles.

According to a third aspect of the invention, use of a rare earth doped metal oxide nanoparticle for the determination of the presence or amount of a compound in a sample is provided.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 illustrates a scheme for synthesizing ZrO²:Tb³⁺ nanoparticles.

FIG. 2 shows the mechanism of the aminolysis reaction of FIG. 1.

FIG. 3 shows (A) a mixture of rare earth metal oxide nanoparticies and pesticides; (B) excitation spectra of the rare earth metal oxide nanoparticles before mixing and of the rare earth metal oxide nanoparticles and pesticides after mixing.

FIG. 4 shows (A) excitation spectra of diluting Tb₂O₃ concentration with hexane, from dilution factor 1 (undiluted) to 10, 15 and 20. The inlet shows the enlarged plot from 1 (undiluted) to 5 times dilution factor; (B) effect of the interparticle distance of Tb₂O₃ on photoluminescent intensity. The inset shows TEM image of Tb₂O₃ nanoparticles with average diameter of 2 nm.

FIG. 5 shows (A) excitation spectral of diluting ZrO:Tb³⁺ concentration with hexane, from dilution factor 1 (undiluted) to 10, 15 and 20. The inset shows the enlarged plot from 1 (undiluted) to 5 times dilution factor; (B) effect of the interparticle distance of ZrO₂:Tb⁺ on PL intensity. The inset shows TEM image of Tb₂O₃ nanoparticles with average diameter of 2 nm. Optimum interparticle distance at 34.4 nm was found to give maximum luminescent intensity.

FIG. 6 shows (A) excitation spectra of ZrO₂:Tb³⁺ (solid line) and Tb₂O₃ (dotted line) in hexane; (B) simplified energy-level diagram of ZrO₂:Tb³⁺ system.

FIG. 7 shows the effect of different solvents on the luminescent intensity of ZrO₂:Tb³⁺ nanoparticles.

FIG. 8 shows (A) excitation spectral of ZrO₂:Tb³⁺ in different solvents including hexane, oleylamine, oleic acid, 1-octadecene and toluene: (B) excitation spectral of ZrO₂:Tb³⁺ showing dose-dependent quenching of the system by various concentrations of oleic acid from 10 to 1,000 ppm.

FIG. 9 shows (A) ZrO₂:Tb³⁺ system's sensitivity responding to different pesticides in the range of 1 to 5 ppm; experiment is done using ZrO₂:Tb³⁺ neat sample as blank; (B) excitation spectral of ZrO₂:Tb³⁺ showing dose-dependent quenching of the system by various concentrations of nitrobenzene from 1 to 5 ppm.

FIG. 10 shows (A) ZrO₂:Tb³⁺ system's sensitivity responding to different pesticides in the range of 1 to 5 ppm; experiment is done by diluting ZrO₂:Tb³⁺ 5 times to achieve the maximum PL intensity and use this as blank; (B) excitation spectral of ZrO₂:Tb³⁺ showing dose-dependent quenching of the system by various concentrations of nitrobenzene from 1 to 5 ppm.

FIG. 11 shows (A) ZrO₂:Tb³⁺ system's sensitivity and stability responding to ppb of pesticide against time; experiment is done by diluting ZrO₂:Tb³⁺ 5 times to achieve the maximum PL intensity and use this as blank; (B) ZrO₂:Tb³⁺ system's sensitivity responding to nitrobenzene and fenitrothion in the range of 0.01 to 5 ppm; same experimental condition as stated as (A).

FIG. 12 shows the dilution effect on the interparticle distance of ZrO₂:Tb³⁺ system.

### DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and changes may be made without departing from the scope of the invention. The various embodiments are not necessarily mutually exclusive, as some embodiments can be combined with one or more other embodiments to form new embodiments.

The present invention is based on a new detection discovery for the sensing technologies using interparticle distance of luminescent rare earth ions of rare earth doped metal oxide nanoparticles. The interparticle distance of the rare earth ions is optimized for the maximum luminescent intensity and this luminescent property is being made use of for sensing applications including, but not limited to, pesticides detection with respect to its luminescent quenched.

One of the impacts of this invention is to develop a nanotechnology-based sensing technique for agriculture products and raise early awareness of food safety for example. The current pesticides detection methods used are mainly gas chromatography coupled to mass spectrometer, liquid chromatography, or biological immunoassay. These methods are usually time consuming, expensive and require skilled labour.

In a first aspect, a method for determining the presence or amount of a compound in a sample by interparticle distance-dependent sensing is provided. The method may include:

(a) contacting the sample suspected of containing the compound with rare earth doped metal oxide nanoparticles; and

(b) detecting the compound by determining the change in luminescent properties of the rare earth doped metal oxide nanoparticles upon contact with the sample.

As used herein, the term “nanoparticle” refers to a nanoscopic particle with a size measured in nanometres (nm). Typically, the nanoparticle has an average width, including diameter, of from about 1 nm to about 500 nm, such as an average diameter of from about 1 nm to about 50 nm, for instance from about 1 nm to about 25 nm. In some embodiments the nanoparticle has a diameter of maximally about 5 nm. In some embodiments the nanoparticle has a diameter of about 2 nm. In particular, the nanoparticle may have an average diameter of from about 1 nm to about 10 nm, such as about 1 nm to about 7 nm, about 1 nm to about 6 nm, about 1 nm to about 5 nm, about 1.5 nm to about 5 nm, about 2 nm to about 5 nm, about 2 nm to about 6 nm, about 2.5 nm to about 5 nm, about 2.5 nm to about 6 nm, about 3 nm to about 6 nm, about 3 nm to about 5 nm, about 4 nm to about 6 nm or about 4 nm to about 5 nm.

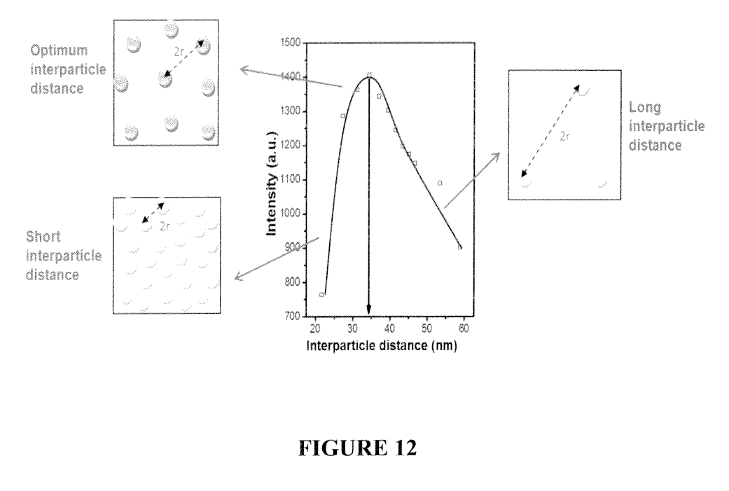

In the present context, the term “interparticle distance” refers to the distance between neighbouring nanoparticles in a macroscopic body (see illustration “2r” in FIG. 12). In a homogeneously dispersed mixture, the distance between neighbouring particles is uniform. For the purposes of the present discussion, the interparticle distance is assumed to be uniform throughout the mixture. As an illustration, the following mathematical calculation is proposed to determine the hypothetical interparticle distances (R) in different concentrations of Tb₂O₃ nanoparticles, assuming each Tb₂O₃ nanoparticle is spherical with a diameter of 2 nm: —

$$R = 2 {( \frac{3 V}{4 π N} )}^{1 / 3} \qquad ( I )$$

where V is the volume and N is the number of Tb³⁺.

In the present context, rare earth elements or rare earth metals are a set of seventeen chemical elements in the periodic table, specifically the fifteen lanthanides plus scandium and yttrium. In various embodiments, the rare earth is selected from the group consisting of Sc, La, Ce, Pr, Nd, Pm, Sm, Eu, Gd, Tb, Dy, Ho, Er, Tm, Yb, Lu, and combinations thereof. In one embodiment, the rare earth is Tb.

In various embodiments, metal oxide nanoparticles useful for the present invention may be selected from the group consisting of ZrO₂, TiO₂, Al₂O₃, MgO, SrO, GeO₂, SiO₂, Ga₂O₃, Y₂O₃, Eu₂O₃, SnO₂, In₂O₃ and combinations thereof. In one embodiment, the rare earth doped metal oxide nanoparticles are formed of ZrO₂:Tb³.

Generally, luminescence refers to the emission of light from substances not resulting from a heat source. For example, luminescent properties may refer to properties of the light emission resulting from a light source (i.e. photoluminescence), or an electric current source (i.e. electroluminescence). For the purposes of facilitating understanding and appreciation of the present invention, unless otherwise stated herein, in the present context reference to luminescent properties means photoluminescent properties. Such properties may include the luminescent intensity of the emitted light and the wavelength of the emitted light, for example.

The present invention provides an alternative technique to the above conventional detection methods by first developing the rare earth doped metal oxide nanoparticles via a ‘greener’ aminolysis route. This aminolysis route is environmentally friendly because, unlike the conventional non-hydrolytic routes, it does not form environmentally unfavorable, volatile alkyl chlorides or hydrogen chloride during the reaction process. In addition, the present invention provides the advantages of enhanced sensitivity selectivity, stability and instantaneous response time over the above-mentioned conventional detection methods. As an example, the detection limit of this sensing technique developed has been demonstrated to be up to the parts-per-million (ppm) and even the parts-per-billion (ppb) level (see Examples section below).

Among the rare earth (RE) ions, trivalent terbium ions (Tb³⁺) have been highly anticipated as one of the most promising species that could provide optical devices in the blue and green regions. Hence, Tb³⁺ are being used for a number of significant biological applications which include biological labels, sensing, and imaging. Therefore, in various embodiments of the present invention. Tb³⁺ are incorporated or doped in metal oxide nanoparticies for interparticle distance-dependent sensing The developed Tb³⁺ doped metal oxide nanoparticles can be utilized as a tool for sensing due to the unique luminescent properties of Tb³⁺ which are related to its electronic energy transition. As discussed earlier with regard to the energy level transition of heavy trivalent RE (n>7), Tb³⁺ can exhibit an intense 4f⁸-4f⁷5d¹ transition besides the intra-configuration f-f transition. The 4f⁷5d¹ levels are influenced to a greater extent by the outer interaction than the 4f-f levels which are well shielded by 5s² and 5p⁶ orbitals. Therefore, this f-d band can be made used of as a sensing tool for fast detection of pesticides with respect to its luminescent quenching. In addition, this f-d band is highly sensitive to the interparticle distance of Tb³⁺ in the solvent and the luminescent efficiency can be maximized once the optimum interparticle distance is determined.

In various embodiments, metal oxide nanoparticles are doped with Tb³⁺ in a 0.1:1 to about 2:1 mole ratio using a high-temperature, non-hydrolytic synthetic aminolysis approach. For example, the nanoparticles are doped with Tb³⁺ in a 1:1 mole ratio.

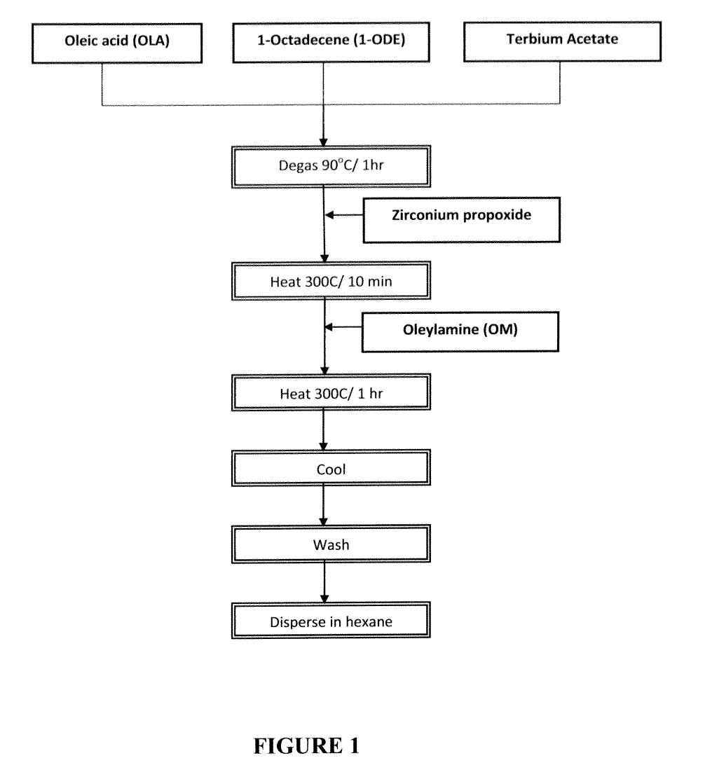

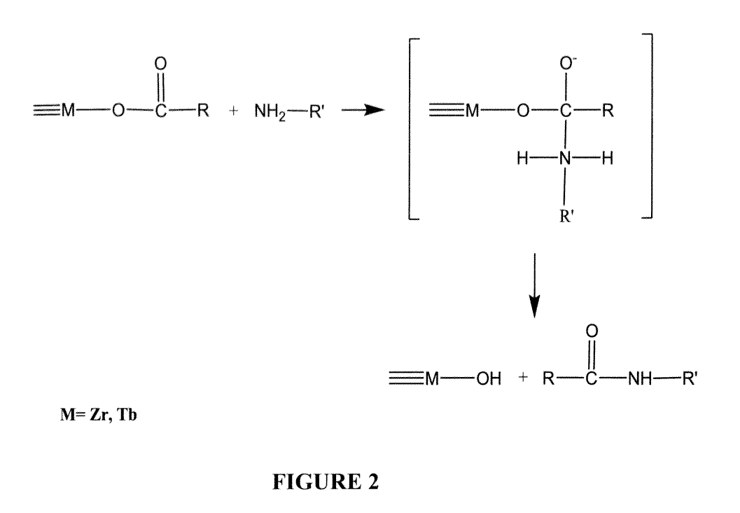

FIG. 1 illustrates the aminolysis approach used to synthesize ZrO₂:Tb³⁺ nanoparticles. This approach resembles the ester aminolysis reaction that involves nucleophilic attack of an amine group from the oleylamine (OM) on the carbonyl carbon atom of the Zr—Tb carboxylate derivatives. As a result, the subsequent polycondensation reaction yields the highly luminescent ZrO₂:Tb³⁺ nanoparticles. The mechanism of this aminolysis reaction is shown in FIG. 2. Details of performing the synthesis reaction will be described in the Examples section below.

Alternatively, the ZrO₂:Tb³⁺ nanoparticles may be formed by other synthesis methods such as water-in oil (W/O) microemulsion, microwave hydrothermal, and coprecipitation, or commercially obtained.

In various embodiments, Tb³⁺ are in an amorphous phase in the ZrO₂:Tb³⁺ nanoparticles. The nanoparticles may be mono-disperse.

In various embodiments, the sample suspected of containing the compound may be contacted with ZrO₂:Tb³⁺ nanoparticles by adding the ZrO₂:Tb³⁺ nanoparticles to the sample. Alternatively, the sample may be added to the ZrO₂:Tb³⁺ nanoparticles.

In various embodiments, the sample is an organic compound.

In various embodiments, the organic compound includes an aromatic moiety or is a triazine compound, an unsaturated fatty acid or an unsaturated amine.

In various embodiments, the aromatic moiety of the organic compound sample is substituted with nitro, organophosphate, amine, and alkyl.

In one embodiment, the organic compound is a pesticide, or a mixture thereof. Generally, a pesticide is any substance, or mixture of substances intended for preventing, destroying, repelling or mitigating any pest. The pesticide may be a chemical substance, biological agent (such as a virus or bacterium), antimicrobial, disinfectant or device used against any pest. Pesticides may include insecticides, fungicides, bactericides, herbicides, and rodenticides.

In various embodiments, the pesticide is selected from the group consisting of nitrobenzene, fenitrothion, paraoxon-methyl, paraoxon-ethyl, and carbaryl.

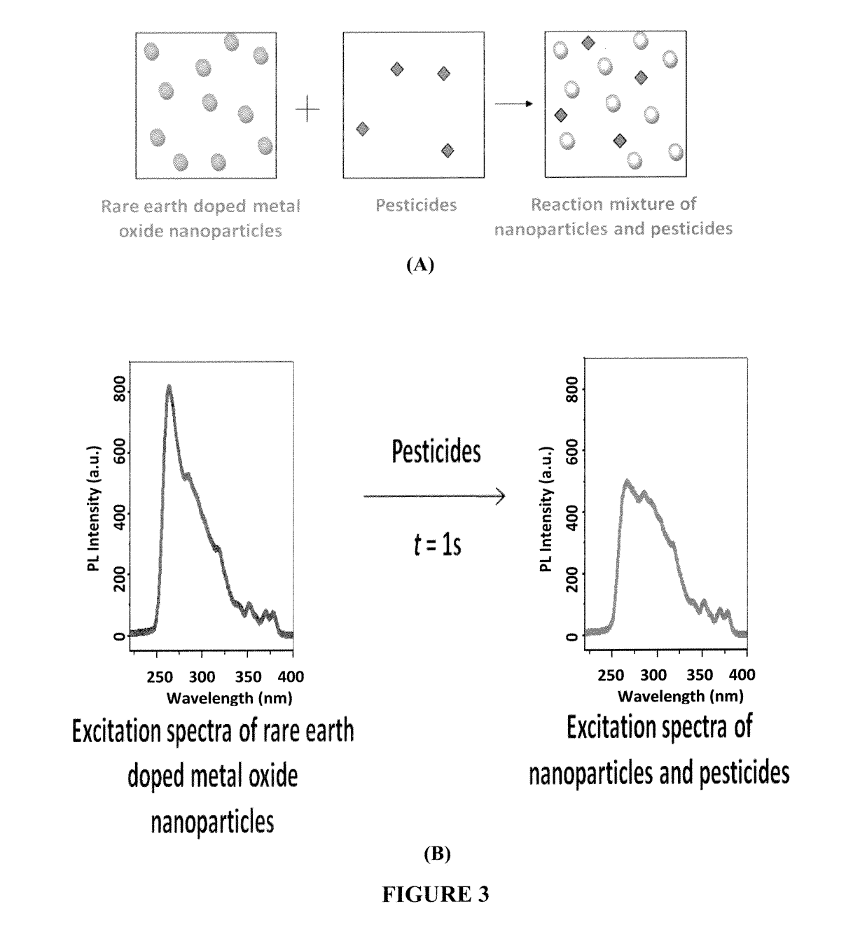

In various embodiments, the ZrO₂:Tb³⁺ nanoparticles are mixed with pesticides such that a mixture of ZrO₂:Tb³⁺ nanoparticles and pesticides is obtained, as shown in FIG. 3(A). The pesticides are detected by determining the change in luminescent properties of the ZrO₂:Tb³⁺ nanoparticles upon contact with the sample. The change in luminescent properties may be detected by irradiating the sample with light of an excitation wavelength and determining the luminescence intensity by detecting the emitted light. The luminescence intensity may be monitored and recorded in a form of an emission spectra.

In various embodiments, the irradiated light has an excitation wavelength of about 200 to about 500 nm. For example, the excitation wavelength may be about 200 nm, 250 nm, 300 nm, 350 nm, 400 nm, 450 nm or 500 nm.

In various embodiments, the emitted light has a wavelength of about 400 to about 750 nm. For example, the emitted light has a wavelength of about 400 nm, 450 nm n 500 nm, 550 nm, 600 nm, 650 nm, 700 nm or 750 nm.

FIG. 3(B) shows the excitation spectra of ZrO₂:Tb³⁺ nanoparticles before mixing with the pesticides, and the excitation spectra of ZrO₂:Tb³⁺ and pesticides after mixing upon being irradiated with light having wavelength of about 200 to 400 nm. After a period of about 1 second of irradiation, it can be clearly seen that the photoluminescent intensity after the mixing has decreased compared to the photoluminescent intensity before mixing.

In various embodiments, prior to contacting the sample suspected of containing the compound with rare earth doped metal oxide nanoparticles, the rare earth doped metal oxide nanoparticles are dispersed in a suitable solvent. The solvent may be an organic solvent.

In certain embodiments, the organic solvent is selected from the group consisting of n-hexane, n-octane, n-dodecane, n-hexadecane, and chloroform.

In various embodiments, the rare earth doped metal oxide nanoparticles are diluted in the solvent such that their luminescence is maximized. In one embodiment, the concentration of ZrO₂:Tb³⁺ nanoparticles in hexane is diluted. The dilution factor may be from 2 to 20, such as 2, 3, 4, 5, 6, 7, 8, 9, 10, 11, 12, 13, 14, 15, 16, 17, 18, 19, or 20.

In various embodiments, the dilution is such that the mean interparticle distance is in the range of 25 to 40 nm for maximum luminescence. For example, the mean interparticle distance may be about 25, 26, 27, 28, 29, 30, 31, 32, 33, 34, 35, 36, 37, 38, 39, or 40 nm.

The dilution effect is illustrated in FIG. 12. Weak luminescence intensity from neat solution (i.e. undiluted solution) could be attributed to the non-radiative and resonant energy transfer between ions (intense Tb³⁺ environment). The luminescence intensity increases a few fold upon initial dilution. However, after reaching the optimum intensity, further diluting the ZrO₂:Tb³⁺ system causes the luminescence to be quenched, i.e. a gradual decrease in the intensity.

In a second aspect, a sensor for use in a method of detecting the presence of amount of a compound in a sample in accordance with the first aspect of the invention is provided. The sensor includes rare earth doped metal oxide nanoparticles as described above.

In order that the invention may be readily understood and put into practical effect, particular embodiments will now be described by way of the following non-limiting examples.

### EXAMPLES

### Example 1

### Synthesis of ZrO₂:Tb³⁺ Nanoparticles

All experiments were carried out by standard oxygen-free techniques under nitrogen flow. In a typical preparation of 50 mol % ZrO₂:Tb³⁺ nanoparticles, a mixed solution of terbium acetate TbAc₃ (0.5 mmol), oleic acid (OLA) (1.6 ml, 5 mmol), and 1-octadecene (1-ODE) (6 ml) was dried and degassed at 90° C. in a 25-ml three-neck flask for 1 h. Then zirconium propoxide (0.23 ml, 0.5 mmol) was injected into the mixed solution and heated for 10 min. The solution gradually turned from colorless to a pale yellow, indicating the formation of zirconium-terbium carboxylate complexes. Gaseous isopropyl alcohol was rapidly released while the mixture was heated to 300° C. for 10 min. The aminolysis reaction was then initiated by rapid injection of 4 mmol of oleylamine (OAm) (13 ml) with vigorous stirring. The resulting solution was kept at 300° C. for 1 h. Then the final mixture was allowed to cool to room temperature. The resulting crude solution of ZrO₂:Tb³⁺ nanoparticles was diluted with hexane (10 ml) followed by precipitation with acetone (20 ml). The crude product was recovered by centrifugation, dispersed in hexane (20 ml), and subjected to a second round of purification. The product obtained can be re-dispersed easily in 30 ml hexane (1 mmol ZrO₂:Tb³⁺/30 ml) for further characterization. It can also be redispersed in other non-polar solvents such as octane, dodecane, hexadecane, chloroform, oleylamine, oleic acid, 1-octadecene and toluene.

### Example 2

### Effects of Diluting Tb₂O₃Nanoparticles

The dispersion of 1 mmol Tb₂O₃ in 30 ml of hexane (undiluted solution) was diluted with hexane from dilution factor 1 (undiluted) to 10, 15 and 20 (diluted solution). The excitation spectra of all prepared solution excited at 546 nm were recorded.

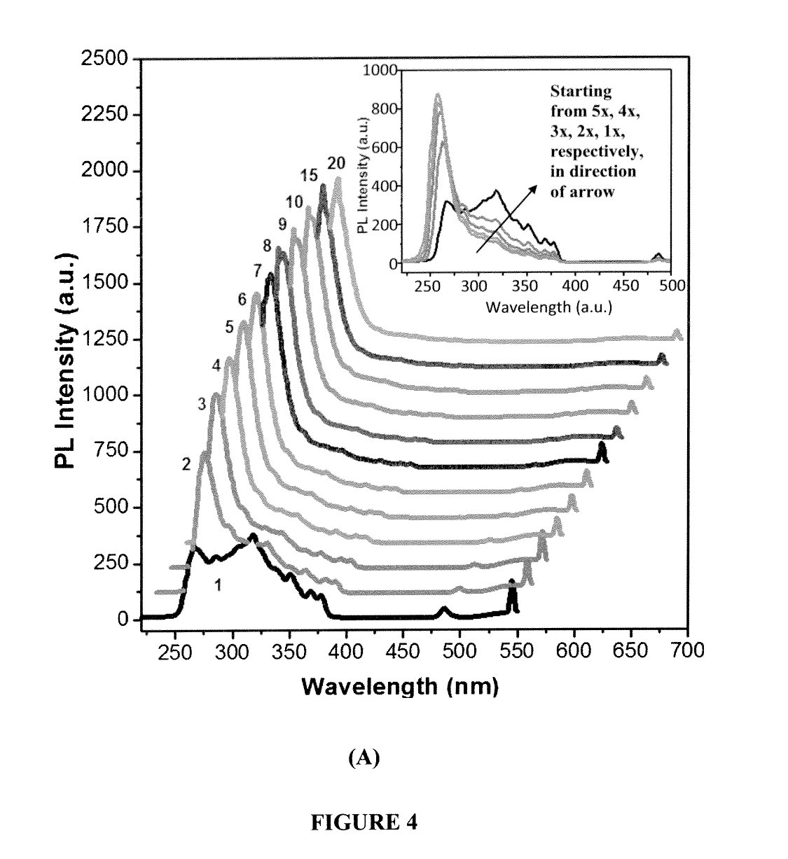

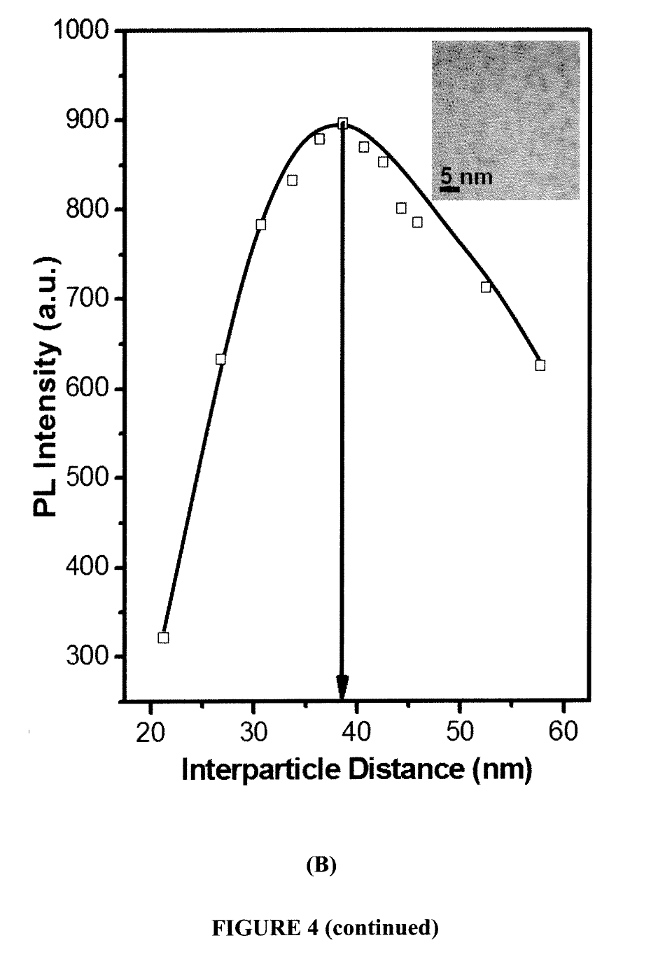

FIG. 4(A) presents the excitation spectra of undiluted Tb₂O₃ and the diluted Tb₂O₃ in hexane. In the undiluted solution, the excitation spectra of Tb₂O₃ excited at 546 nm displays the excitation maximum at 260 and 320 nm. An interesting phenomenon occurs for the f-d band at 260 nm upon dilution. This band at 260 nm is hypersensitive to the changes of the Tb³⁺ concentration in hexane and the luminescent intensity increases remarkably as the concentration gets more diluted. This sensitivity can be explained by the intensity of 4f-5d level of Tb³⁺ which is greatly influenced by their surroundings due to the lack of shielding effect by the outer 5s and 5p orbitals that will be discussed in the later section. On the contrary, the luminescence intensity for the f-f band at 320 nm reduces as the concentration gets lower as anticipated. In order to study the effect of interparticle distance on the PL intensity, the hypothetical interparticle distances (R) in different concentrations assuming each Tb₂O₃ particle is spherical with 2 nm in diameter was calculated based on the mathematical formula (I) above.

FIG. 4(B) shows the influence of interparticle distance of Tb₂O₃ particles on luminescence intensity. The luminescence intensity of undiluted solution is weak which probably due to the non-radiative and resonant energy transfer between the excited donors (Tb³⁺) to the acceptor (Tb³⁺). The short interparticle distance of 21.2 nm revealed the close packing of Tb³⁺ which promotes the energy transfer from one to another through a resonance process: the energy eventually dissipated by non-radiative processes rather than by emission of visible light. The luminescence intensity increases upon diluting to a less concentrated Tb³⁺ environment and it almost increases three fold after six times dilution with hexane. Here, the luminescence intensity reaches a maximum and the interparticle distance was determined to be 38.6 nm. Further diluting the system causes the luminescence to be quenched. In other words, after reaching the optimum distance, interparticle distance of greater than 38.6 nm reduces the luminescence intensity gradually.

### Example 3

### Effects of Diluting ZrO:Tb³⁺ Nanoparticles

The dispersion of 1 mmol ZrO₂:Tb³⁺ in 30 ml of hexane (undiluted solution) was diluted with hexane from dilution factor 1 (undiluted) to 10, 15 and 20 (diluted solution). The excitation spectra of all prepared solution excited at 546 nm were recorded.

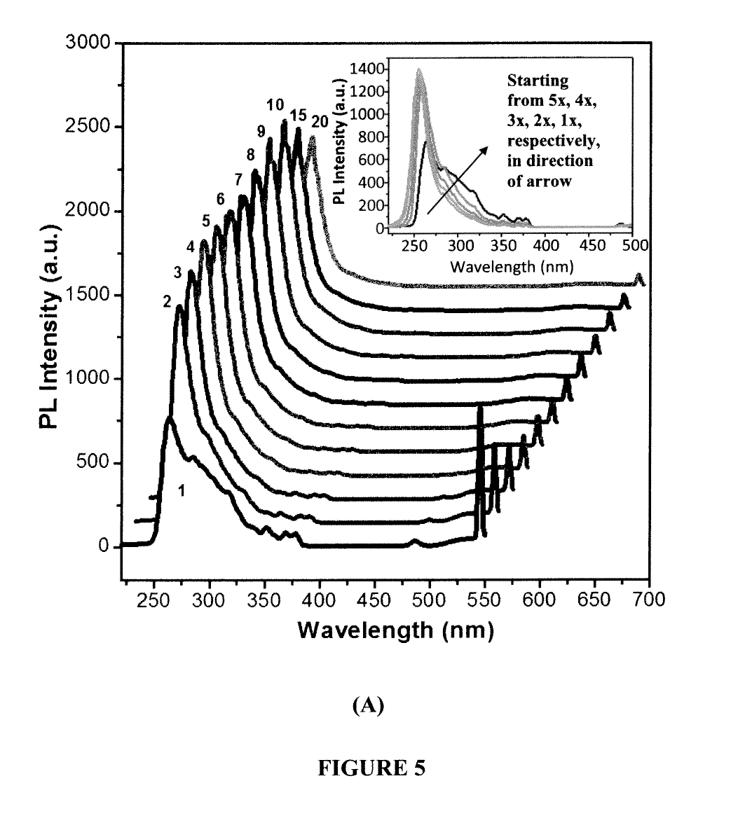

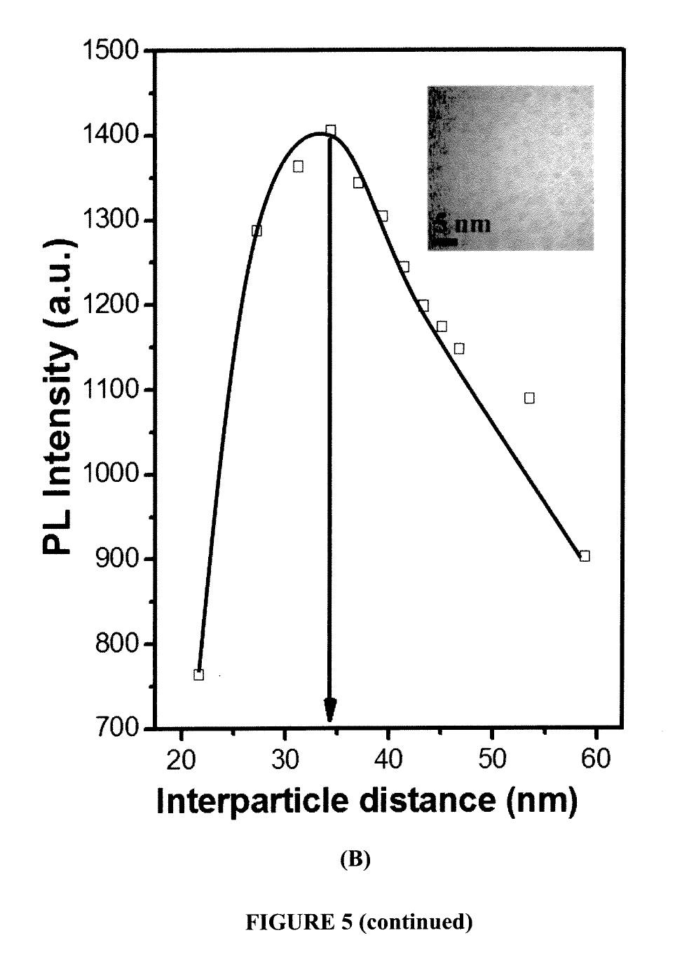

FIG. 5(A) presents the excitation spectra of undiluted ZrO₂:Tb³⁺ and the diluted ZrO₂:Tb³⁺ in hexane. In the undiluted solution, the excitation spectral of ZrO₂:Tb³⁺ excited at 546 nm shows an excitation maximum at 263 nm. This f-d band intensity changes with the concentration of the ZrO₂:Tb³⁺ particles in hexane which increase significantly after dilution. This observation has been previously seen in the Tb₂O₃ system indicates the sensitivity of f-d band.

FIG. 5(B) shows the influence of interparticle distance of ZrO₂:Tb³⁺ particles on luminescence intensity. The luminescence intensity of undiluted solution is again low which has been observed from the same phenomenon as FIG. 4. With an increase of Tb³⁺ concentration, the distance between Tb³⁺ decreases: a fast diffusion process is responsible for the energy migration between the Tb³⁺ which result in non-radiative decay process as discussed earlier. Diluting the system to a less concentrated Tb³⁺ environment results in a higher luminescence; it almost increases two fold after four times dilution with hexane. The luminescence intensity reaches a maximum at an interparticle distance of 34.4 nm. Similarly, further diluting the system causes the luminescence to quench.

The other particularly noteworthy point is that the present method produces the Tb³⁺ in amorphous phase rather than crystalline phase. This suggests that there is no crystal defects in the system. Thus, it will not lead to high concentration of luminescent quenching centers. Without the limitation of crystal lattice, Tb³⁺ are able to be well dispersed in the system. Consequently, excited Tb³⁺ will tend to de-excite radiatively resulting in high luminescent efficiency.

### Example 4

### Comparison between Tb₂O₃ and ZrO:Tb³⁺ Systems

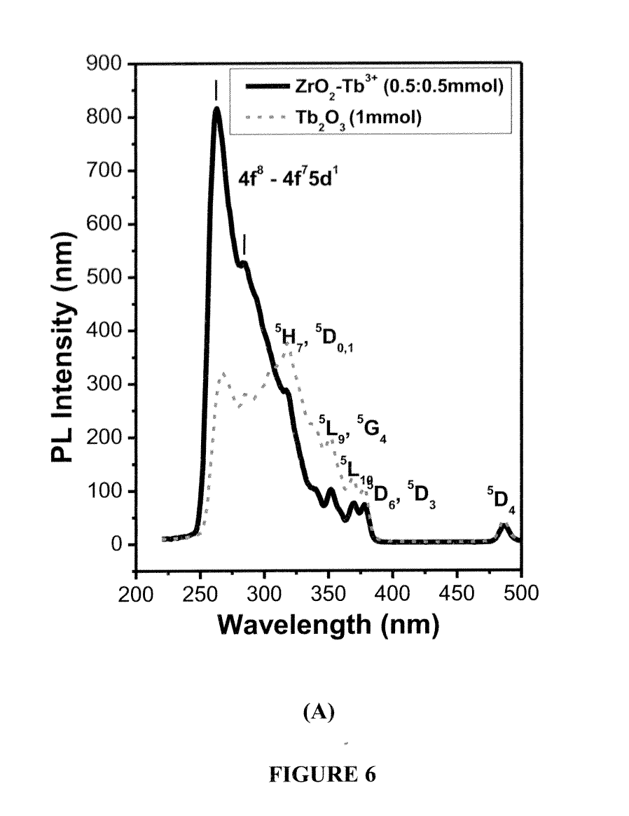

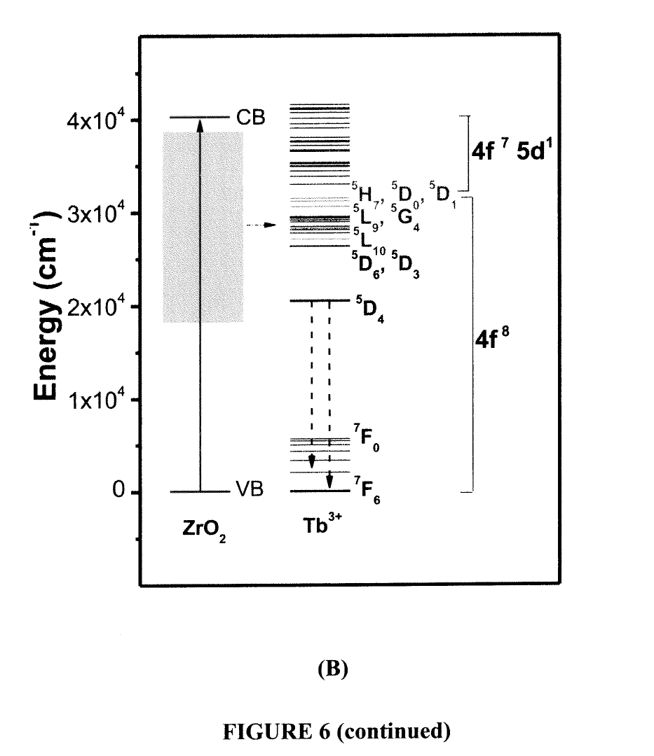

FIG. 6(A) presents the excitation spectral of ZrO₂:Tb and Tb₂O₃ in the wavelength region of 220 to 500 nm with the green emission at 546 nm. The excitation spectra comprises of two types of transitions: f→f transition (300 to 500 nm) and f→d transition (220 to 300 nm). The f→d transition is extremely sensitive to foreign influences due to the lack of shielding effect by the outer 5s and 5p orbitals. On the contrary, f→f transition in which the 4f orbital is found to be well shielded by the outer orbitals, hence, the energy levels of 4f electrons are not strongly perturbed by their surroundings.

A sharp and intense peak at 263 nm is found in ZrO₂:Tb³⁺ which corresponds to the 4f⁵-4f⁷ 5d¹ transition or simply the f-d band. The f→f transition peaks centered at 487, 378, 369, 352, 317 nm have been assigned to the transition from ground state F₆ to the higher excited levels of ⁵D₄, (⁵D₃, ⁵D₆, ⁵L₁₀, (⁵L₉, ⁵G₄), ⁵D_{0, 1}) respectively as shown in FIG. 6(B). On the other hand, the luminescent intensity of Tb₂O₃ is significant weaker and two prominent peaks are found at 268 and 318 nm which corresponds to the f-d transition and f→f transition respectively. In comparison with ZrO₂:Tb³⁺ the luminescent intensity of Tb₂O₃ has been remarkably enhanced by substituting 50 mmol % of Tb³⁺ with ZrO₂. This luminescent enhancement is noticeable especially at 250 to 300 nm band and small changes to 300 to 500 nm band. The weak f-d band (200 to 300 nm) in the Tb₂O₃ excitation spectral is attributed to the high concentration of Tb³⁺ which promotes the interaction between the excited and unexcited Tb³⁺ via non-radiative energy transfer process. On the other hand, substituting 50% of Tb³⁺ with ZrO₂ ions enhances the f-d band luminescent by dispersing the Tb³⁺ distance apart and consequently minimizes the non-radiative energy transfer process. There is no obvious change in the f-f band (300 to 500 nm) between ZrO₂:Tb³⁺ and Tb₂O₃ since these transitions occur in the f-f electron configurations and 4f shell is well shielded.

In addition to the interparticle distance-dependent luminescent in the f-d band region, the incorporation of Tb³⁺ in the ZrO₂ matrix could induce the energy transfer from ZrO₂ to Tb³⁺. The remarkable enhanced in luminescent from region 220 to 300 nm could be attributed to strong absorption of the donor (ZrO₂) in the 200 to 300 nm UV region which excite a strong f-d transition in Tb³⁺.

### Example 5

### Effect of Solvents on Luminescent Properties of ZrO₂:Tb³⁺ Nanoparticles

The type of solvent influences the luminescence intensity of the ZrO₂:Tb³⁺ nanoparticles. Therefore, an attempt was made to determine the best dispersing medium for the synthesized nanoparticles.

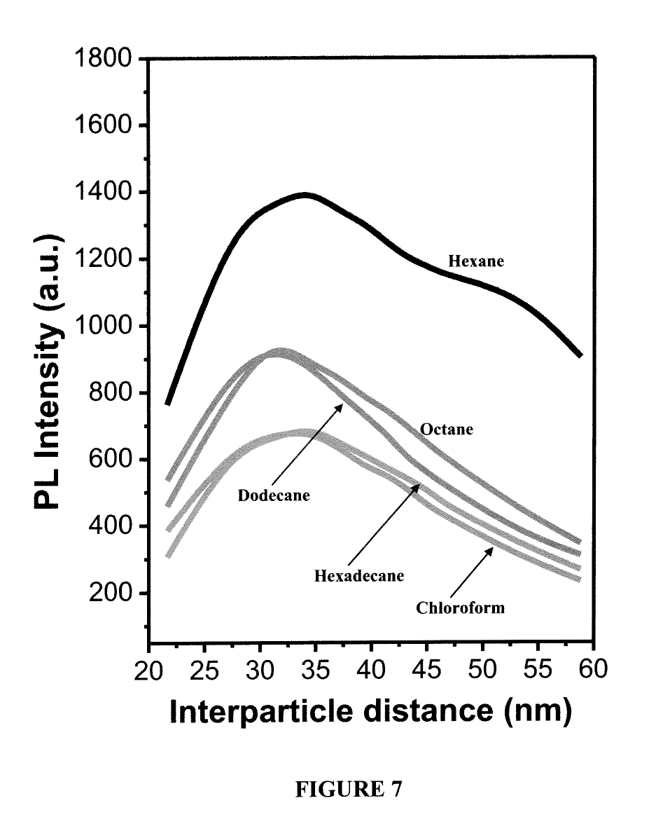

FIG. 7 shows that optimum condition can be obtained from hexane followed by octane, dodecane, chloroform and hexadecane. Similarly, these solvents demonstrate the same phenomenon upon diluting the ZrO₂:Tb³⁺ nanoparticles in the respective solvents and this has been discussed in the earlier section with reference to FIG. 4 and FIG. 5. The effect of dilution in various solvent reveals that optimum interparticle distance is range in between 31 and 34 nm for the maximum luminescent intensity and this trend observed is independent of the solvent use.

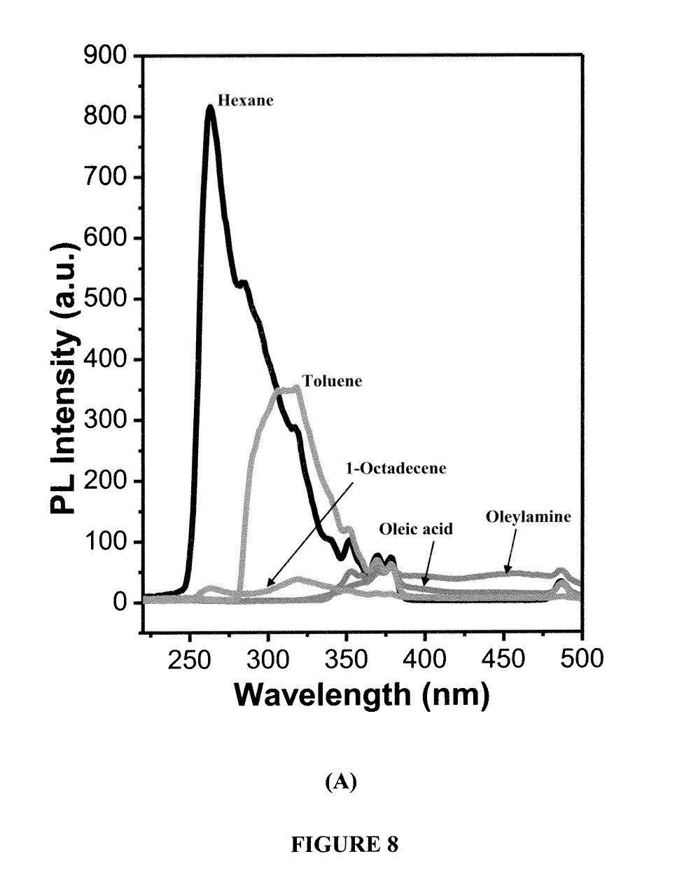

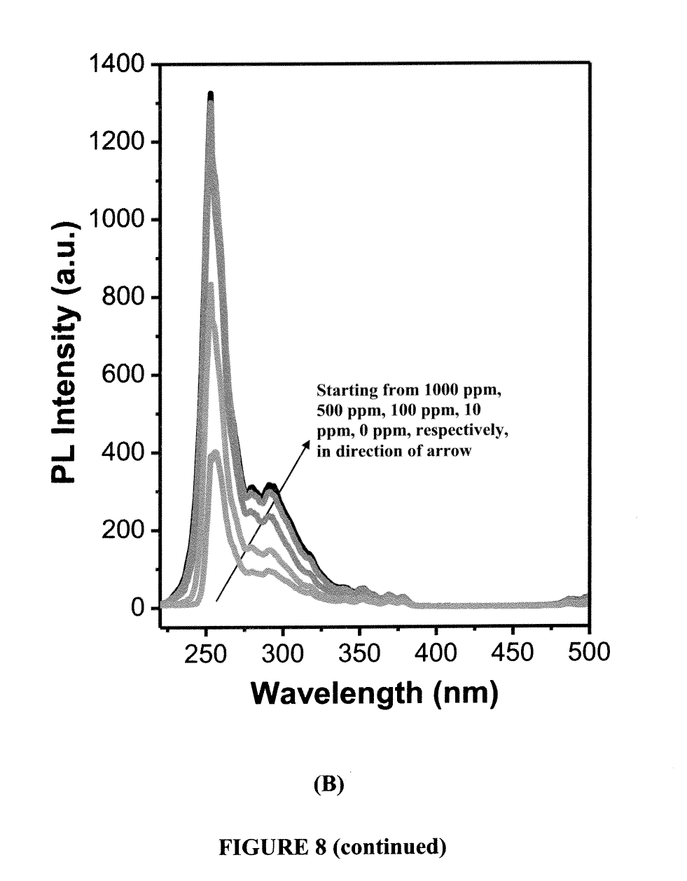

The effect of solvent on the luminescent properties of ZrO₂:Tb³⁺ system is further investigated in other organic solvents with functional groups such as oleymine, oleic acid, 1-octadecene and toluene as illustrated in FIG. 8(A). Excitation spectra shows that the f-d transition band of ZrO₂:Tb³⁺ in toluene is completely quenched while the f→f transition bands remained. As a result, the peak at 317 nm becomes the most intense peak. As for the long carbon chain solvents such as oleymine, oleic acid. 1-octadecene, the luminescent intensity is quenched to a minimal. The prominent peaks at 263 nm and 317 nm are diminished in these solvents. FIG. 8(B) displays the effect of oleic acid concentration on the luminescent intensity of ZrO:Tb³⁺ system. Here, hexane is used as the dispersing medium. A greater extent of quenching efficiency can be observed from the f-d transition band at 263 nm when oleic acid is doped into the ZrO₂:Tb³⁺ system. With an increase of oleic acid concentration beginning from 10 to 100 ppm, the luminescent intensity of ZrO₂:Tb³⁺ reduces gradually. Further increase in oleic acid concentration up to 500 and 1,000 ppm causes the luminescent intensity to quench drastically. From this result, it is discovered that the sensitivity of the f-d transition band towards certain functional group while dispersing the ZrO₂:Tb³⁺ nanoparticles in different solvents. Therefore, this properties can be exploited as a sensing tool for pesticides detection.

### Example 6

### Response of ZrO₂:Tb³⁺ Nanoparticies to Pesticides

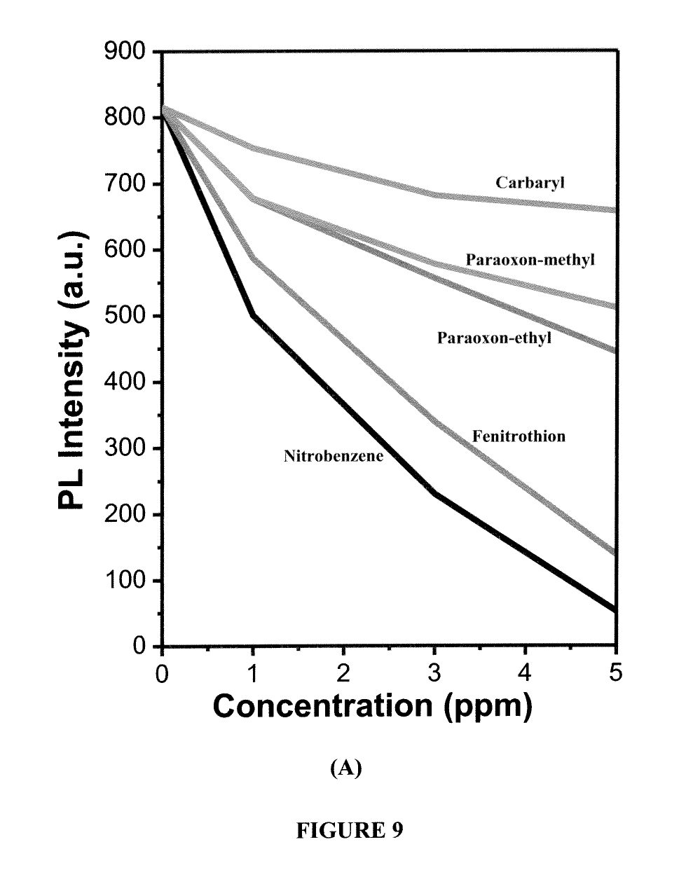

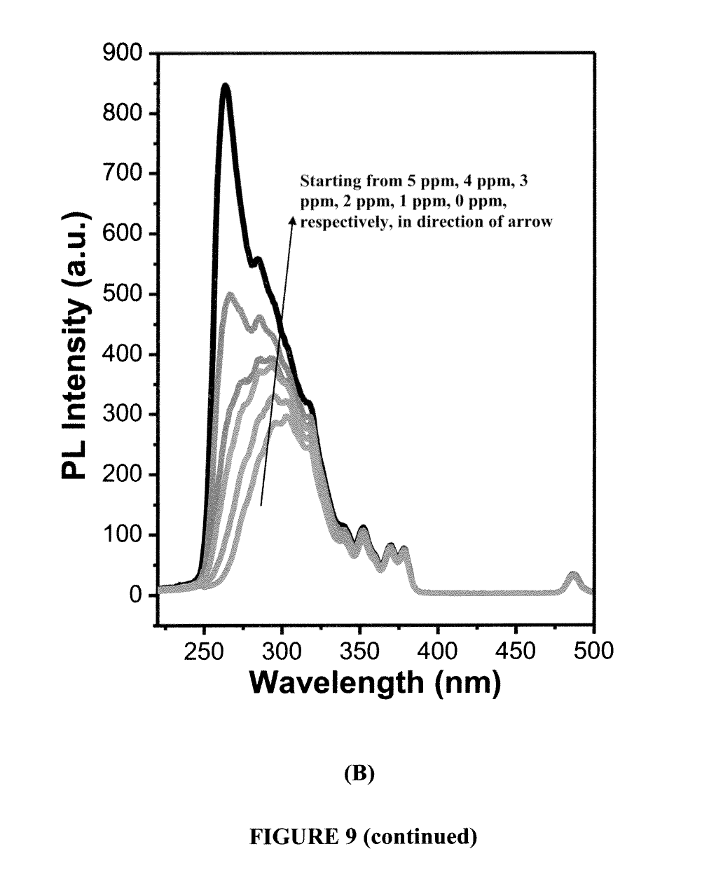

FIG. 9(A) presents the sensitivity of f-d band of ZrO₂:Tb³ b at 263 nm responding to pesticides from 1 to 5 ppm. The pesticides tested are nitrobenzene, fenitrothion, paraoxon ethyl, paraoxon methyl and carbaryl and luminescent intensity is measured instantly upon pesticides addition. The order of sensitivity to pesticides is arranged in the order of nitrobenzene>fenitrothion>paraoxon-ethyl>paraoxon-methyl>carbaryl. The ZrO₂:Tb³⁺ system is especially sensitive towards nitrobenzene and fenitrothion. FIG. 9(B) shows the excitation spectra doped with 1 to 5 ppm of nitrobenzene. Results reveal the excellent quenching efficiency of nitrobenzene at the f-d transition band even at 1 ppm level.

To further enhance the luminescent efficiency, ZrO₂:Tb³⁺ nanoparticles in hexane is diluted to 5 fold to increase the interparticle distance of ZrO₂:Tb³⁺ ions.

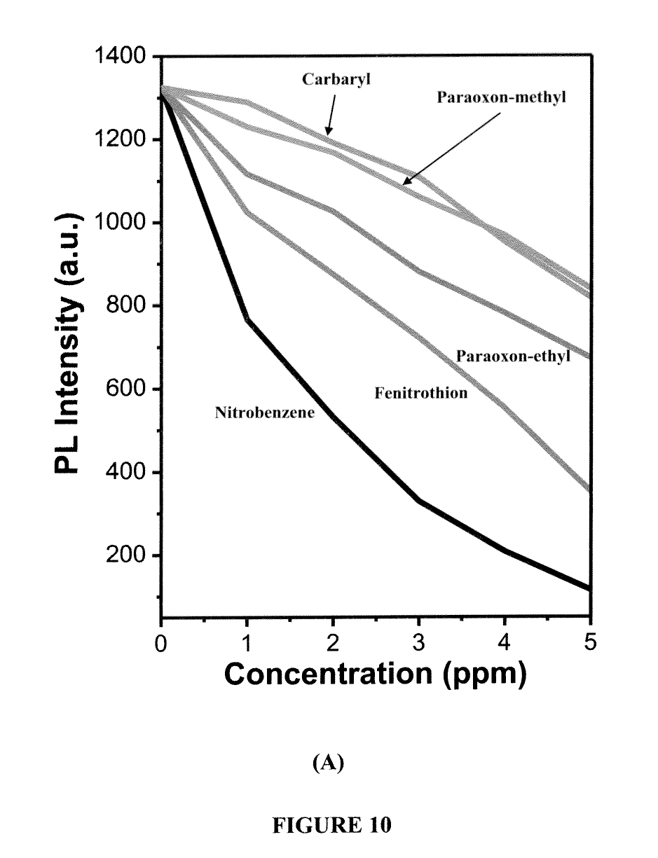

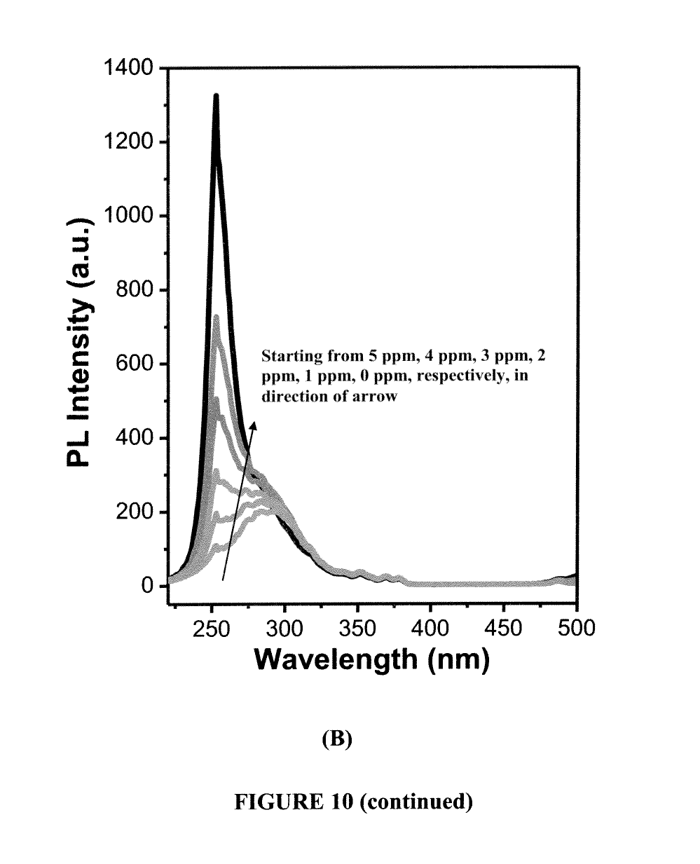

FIG. 10 shows (A) ZrO₂:Tb³⁺ system's sensitivity responding to different pesticides in the range of 1 to 5 ppm; experiment is done by diluting ZrO₂:Tb³⁺5 times to achieve the maximum PL intensity and use this as blank; (B) excitation spectral of ZrO₂:Tb³⁺ showing dose-dependent quenching of the system by various concentrations of nitrobenzene from 1 to 5 ppm.

Upon optimising the interparticle distance of the ions, these ions are well dispersed in the solvent and consequently minimize the non-radiative energy transfer process. Therefore, luminescent sensitivity has been enhanced to a greater extent. Similarly, five pesticides tested are nitrobenzene, fenitrothion, paraoxon ethyl, paraoxon methyl and carbaryl. The results reveal that the sensing sensitivity has been further improved due to a greater quenching efficiency achieved. This sensing is particularly sensitive towards nitrobenzene and fenitrothion compared to others.

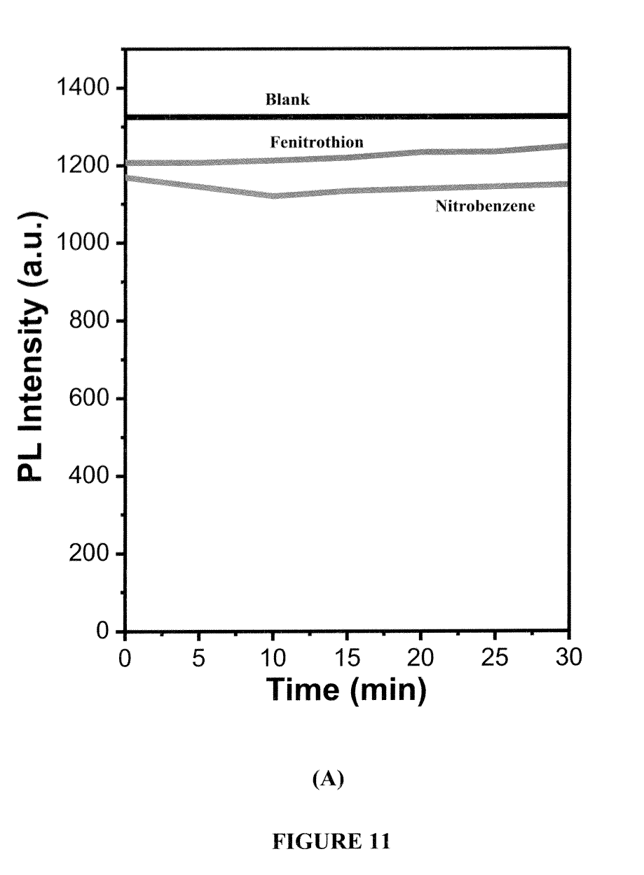

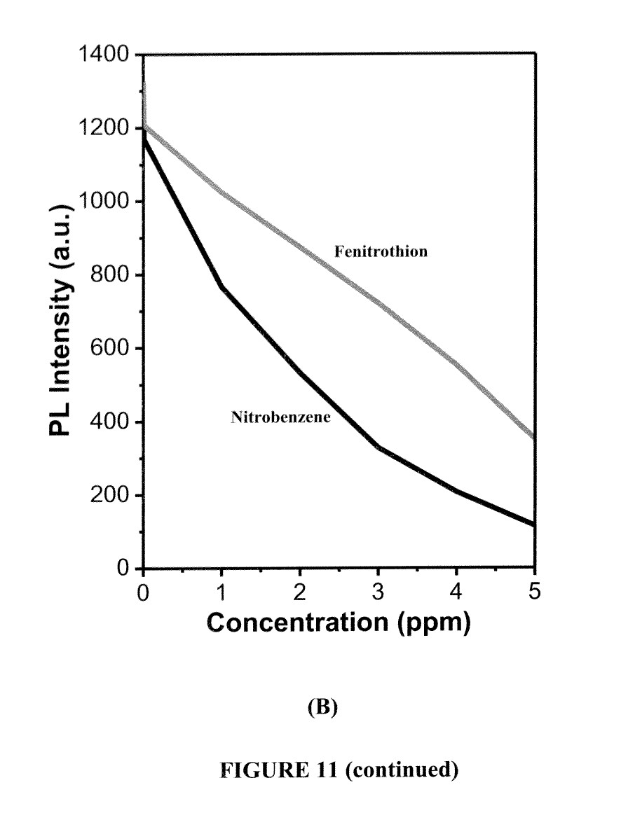

The limit of detection is further investigated down to ppb level. The diluted ZrO₂:Tb³⁺ nanoparticles in hexane is tested with the two most sensitive pesticides such as nitrobenzene and fenitrothion. The response of optimized ZrO₂:Tb³⁺ is measured with time when 10 ppb of pesticide is added. Luminescent result in FIG. 11(A) indicates the instantaneous quenching of luminescent and this signal is stable over time up to 30 minutes. FIG. 11(B) displays the corrected luminescent quenched from nitrobenzene and fenitrothion in 0.01 to 5 ppm range. The above findings are definitely promising in terms of sensitivity, selectivity, stability and response time. The benefits in ZrO₂:Tb³⁺ using interparticle distance-dependent sensing is a new discovery to the next generation sensing technologies and ideally this sensing approach can be further developed for military and civilian use, for example.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

1. A method for determining the presence or amount of a compound in a sample by interparticle distance-dependent sensing, comprising:
(a) contacting the sample suspected of containing the compound with rare earth doped metal oxide nanoparticles; and
(b) detecting the compound by determining the change in luminescent properties of the rare earth doped metal oxide nanoparticles upon contact with the sample.

2. The method of claim 1, wherein the rare earth doped metal oxide nanoparticles are dispersed in an organic solvent.

3. The method of claim 2, wherein the solvent is selected from the group consisting of n-hexane, n-octane, n-dodecane, n-hexadecane, and chloroform.

4. The method of claim 2, wherein the rare earth doped metal oxide nanoparticles are diluted in the solvent such that their luminescence is maximized.

5. The method of claim 4, wherein the dilution is such that the mean interparticle distance is in the range of 25 to 40 nm.

6. The method of claim 1, wherein the rare earth ions of the rare earth doped metal oxide nanoparticles are in an amorphous phase.

7. The method of claim 1, wherein the metal oxide is selected from the group consisting of ZrO₂, TiO₂, Al₂O₃, MgO, SrO, GeO₂, SiO₂, Ga₂O₃, Y₂O₃, Eu₂O₃, SnO₂, In₂O₃ and combinations thereof.

8. The method of claim 1, wherein the rare earth is selected from the group consisting of Sc, La, Ce, Pr, Nd, Pm, Sm, Eu, Gd, Tb, Dy, Ho, Er, Tm, Yb, Lu, and combinations thereof.

9. The method of claim 1, wherein the rare earth doped metal oxide nanoparticle is a ZrO₂:Tb nanoparticle.

10. The method of claim 1, wherein the compound comprises an aromatic moiety or is a triazine compound, an unsaturated fatty acid or an unsaturated amine.

11. The method of claim 10, wherein the compound is a pesticide selected from the group consisting of nitrobenzene, fenitrothion, paraoxon-methyl, paraoxon-ethyl, and carbaryl.

12. The method of claim 1, wherein, the detecting step comprises irradiating the sample with light of an excitation wavelength and determining the luminescence intensity by detecting the emitted light.

13. The method of claim 13, wherein the irradiated light has an excitation wavelength of about 200 to about 500 nm.

14. Sensor for use in a method of detecting the presence of amount of a compound in a sample, wherein the sensor comprises rare earth doped metal oxide nanoparticles.

15. The sensor of claim 14, wherein the rare earth ions of the rare earth doped metal oxide nanoparticles are in an amorphous phase.

16. The sensor of claim 14, wherein the metal oxide is selected from, the group consisting of ZrO₂, TiO₂, Al₂O₃, MgO, SrO, GeO₂, SiO₂, Ga₂O₃, Y₂O₃, Eu₂O₃, SnO₂, In₂O₃ and combinations thereof.

17. The sensor of claim 14, wherein the rare earth is selected from the group consisting of Sc, La, Ce, Pr, Nd, Pm, Sm, Eu, Gd, Tb, Dy, Ho, Er, Tin, Yb, Lu, and combinations thereof.

18. The sensor of claim 14, wherein the rare earth doped metal oxide nanoparticle is a ZrO₂:Tb nanoparticle.

19. Use of a rare earth doped metal oxide nanoparticle for the determination of the presence or amount of a compound in a sample.

20. The use of claim 19, wherein the rare earth doped metal oxide nanoparticle is a ZrO₂:Tb nanoparticle.
